(19) United States
(12) Patent Application Publication
(10) Pub. No.: US 2024/0042420 A1
(43) Pub. Date: Feb. 8, 2024

(54) EXHAUST GAS PURIFICATION CATALYST

(71) Applicant: TOYOTA JIDOSHA KABUSHIKI KAISHA, Toyota-shi (JP)

(72) Inventors: Hiroyuki ISHIKAWA, Anjo-shi, (JP); Masahide MIURA, Toyota-shi (JP); Hiroki SHIRAKAWA, Toyota-shi (JP); Takahiro HAYASHI, Susono-shi (JP)

(73) Assignee: TOYOTA JIDOSHA KABUSHIKI KAISHA, Toyota-shi (JP)

(21) Appl. No.: 18/205,300

(22) Filed: Jun. 2, 2023

(30) Foreign Application Priority Data
Aug. 2, 2022 (JP) 2022-123435

(51) Int. Cl. B01J 23/46; B01J 21/06; B01J 21/04; B01J 35/00; B01J 35/10; B01D 53/86

(52) U.S. Cl. CPC B01J 23/464; B01J 21/066; B01J 21/04; B01J 35/006; B01J 35/0066; B01J 35/0013; B01J 35/1014; B01J 35/1019; B01D 53/8628; B01D 2255/1025; B01D 2255/20715; B01D 2255/9202

(57) ABSTRACT

The present disclosure provides an exhaust gas purification catalyst with increased exhaust gas purification performance. The exhaust gas purification catalyst has a porous support, catalyst metal particles supported in the pores of the porous support, and zirconium dioxide particles supported in the pores of the porous support. The zirconium dioxide particles are supported in a uniformly dispersed manner in the pores, as monoclinic crystals or a mixture of monoclinic crystals and tetragonal crystals, the phrase “supported in a uniformly dispersed manner” meaning that when the exhaust gas purification catalyst is measured with an electron beam microanalyzer, the proportion of the abundance ratio of zirconium in a surface region up to a depth of 1.5 μm from the exhaust gas purification catalyst surface with respect to the abundance ratio of zirconium in the region inward from that surface region of the exhaust gas purification catalyst, is 95 to 105 mol %.

### FIELD

The present disclosure relates to an exhaust gas purification catalyst.

### BACKGROUND

PTL 1 discloses an exhaust gas purification catalyst that includes one or more precious metals selected from the group consisting of Pt, Pd and Rh, and a complex compound with one or more metal elements selected from the group consisting of Al, Ce, La, Zr, Co, Mn, Fe, Mg, Ba and Ti uniformly dispersed in one or more oxides selected from the group consisting of Al₂O₃, ZrO₂ and CeO₂, wherein the precious metal is supported on the complex compound with part of the surface area of the precious metal being covered by the complex compound.

### CITATION LIST

### Patent Literature

[PTL 1] Japanese Unexamined Patent Publication No. 2006-198594

### SUMMARY

### Technical Problem

It is a desirable goal to increase exhaust gas purification performance.

It is an object of the present disclosure to provide an exhaust gas purification catalyst that has increased exhaust gas purification performance.

### Solution to Problem

The present inventors have found that the aforementioned object can be achieved by the means described below.

### Aspect 1

An exhaust gas purification catalyst having a porous support, catalyst metal particles supported in the pores of the porous support, and zirconium dioxide particles supported in the pores of the porous support,
wherein the zirconium dioxide particles are supported in a uniformly dispersed manner in the pores of the porous support as monoclinic crystals or a mixture of monoclinic crystals and tetragonal crystals,
where “supported in a uniformly dispersed manner” means that when the exhaust gas purification catalyst is measured with an electron beam microanalyzer, the proportion of the abundance ratio of zirconium in a surface region up to a depth of 1.5 μm from the exhaust gas purification catalyst surface with respect to the abundance ratio of zirconium in the region inward from that surface region of the exhaust gas purification catalyst, is 95 to 105 mol %.

### Aspect 2

The exhaust gas purification catalyst according to aspect 1, wherein the zirconium dioxide particles are monoclinic crystals.

### Aspect 3

The exhaust gas purification catalyst according to aspect 1 or 2, wherein the ratio of the mass of the zirconium dioxide particles with respect to the mass of the porous support is 0.1 to mass %.

### Aspect 4

The exhaust gas purification catalyst according to any one of aspects 1 to 3, wherein the crystallite diameters of the zirconium dioxide particles are 6.0 to 8.0 nm.

### Aspect 5

The exhaust gas purification catalyst according to any one of aspects 1 to 4, wherein the secondary particle size (D50) of the zirconium dioxide particles is 40 nm or smaller.

### Aspect 6

The exhaust gas purification catalyst according to any one of aspects 1 to 5, wherein the catalyst metal particles are Rh particles.

### Aspect 7

The exhaust gas purification catalyst according to any one of aspects 1 to 6, wherein the ratio of the mass of the catalyst metal particles with respect to the mass of the porous support is to 2.0 mass %.

### Aspect 8

The exhaust gas purification catalyst according to any one of aspects 1 to 7, wherein the primary particle size (D50) of the catalyst metal particles is 1.0 to 9.0 nm.

### Aspect 9

The exhaust gas purification catalyst according to any one of aspects 1 to 8, wherein the porous support is a complex oxide of Al and Zr.

### Aspect 10

The exhaust gas purification catalyst according to any one of aspects 1 to 9, wherein the initial area-to-weight ratio of the porous support is 45 to 115 m²/g.

### ADVANTAGEOUS EFFECTS OF INVENTION

According to the disclosure it is possible to provide an exhaust gas purification catalyst with increased exhaust gas purification performance.

### BRIEF DESCRIPTION OF DRAWINGS

FIG. 1 is a schematic diagram showing exhaust gas purification catalyst particles according to an embodiment of the disclosure.

FIG. 2A is a scanning electron microscope (SEM) image of the exhaust gas purification catalyst particles of Comparative Example 2.

FIG. 2B is a scanning electron microscope (SEM) image of the exhaust gas purification catalyst particles of Comparative Example 2 with outlining of the surface region and the region further inward from the surface region.

FIG. 3A is a Zr mapping image obtained from an electron beam microanalyzer (EMPA) of the exhaust gas purification catalyst particles of Example 1.

FIG. 3B is a Zr mapping image obtained from an electron beam microanalyzer (EMPA) of the exhaust gas purification catalyst particles of Comparative Example 2.

FIG. 4 is a graph showing the temperature at which 50% purification of NOx is achieved with the exhaust gas purification catalyst particles of Examples 1 to 6 and Comparative Examples 1 to 6.

### DESCRIPTION OF EMBODIMENTS

Embodiments of the disclosure will now be described in detail. The disclosure is not limited to the embodiments described below, however, and various modifications may be implemented which do not depart from the gist thereof

### Exhaust Gas Purification Catalyst

The exhaust gas purification catalyst of the disclosure comprises a porous support, catalyst metal particles supported in the pores of the porous support, and zirconium dioxide (ZrO₂) particles supported in the pores of the porous support. The zirconium dioxide particles are supported in a uniformly dispersed manner inside the pores of the porous support. The zirconium dioxide particles are monoclinic crystals or a mixture of monoclinic crystals and tetragonal crystals.

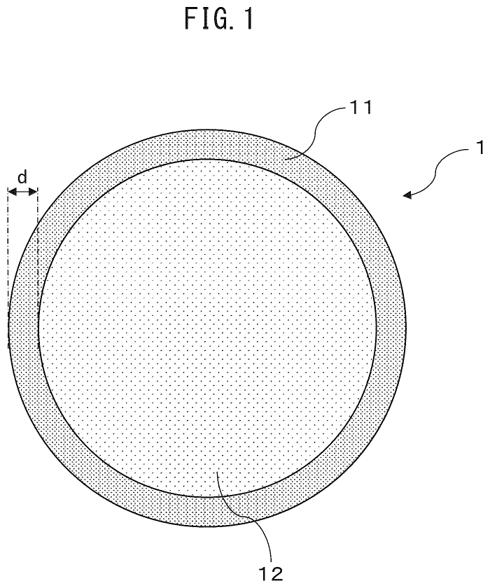

The phrase “supported in a uniformly dispersed manner” means that when the exhaust gas purification catalyst is measured using an electron beam microanalyzer, the percentage of the abundance ratio of zirconium in the surface region 11 from the surface of the exhaust gas purification catalyst 1 to a depth d of 1.5 μm, with respect to the abundance ratio of zirconium in the region 12 inward from the surface region 11 of the exhaust gas purification catalyst 1, is 95 to 105 mol %, as shown in FIG. 1.

It is possible, although not essential, that the principle by which the exhaust gas purification performance is improved by the exhaust gas purification catalyst of the disclosure is as follows.

Generally speaking, catalyst metal particles in an exhaust gas purification catalyst tend to form a solid solution and atomize on the support while being repeatedly exposed to a hot acidic/reducing atmosphere during the process of purifying exhaust gas, thereby diffusing through the gas phase and moving into honeycomb substrate in which another support or exhaust gas purification catalyst is disposed, and becoming inactivated.

The exhaust gas purification catalyst of the disclosure has zirconium dioxide particles, as monoclinic crystals or a mixture of monoclinic crystals and tetragonal crystals, in close contact with catalyst metal particles, thereby inhibiting diffusion of the catalyst metal particles into the gas phase by solid solution in the support and atomization, and helping to improve the catalytic activity.

More specifically, the zirconium dioxide particles as monoclinic crystals or a mixture of monoclinic crystals and tetragonal crystals have greater surface energy compared to supports commonly used for exhaust gas purification catalysts, such as Al₂O₃ or CeO₂, or complex oxide particles comprising Al, Ce and Zr. Zirconium dioxide particles have no lattice matching with catalyst metal oxides such as rhodium oxide. This is thought to be the reason inhibiting solid solution and atomization of catalyst metal particles during purification of exhaust gas with an exhaust gas purification catalyst.

Zirconium dioxide particles, as monoclinic crystals or a mixture of monoclinic crystals and tetragonal crystals, can also reduce catalyst metals such as Rh at lower temperature than cubic or tetragonal zirconium dioxide.

However, because zirconium dioxide particles as monoclinic crystals or a mixture of monoclinic crystals and tetragonal crystals lack high heat resistance, they can aggregate in high-temperature atmospheres, resulting in particle growth. The exhaust gas purification catalyst of the disclosure therefore has the zirconium dioxide particles supported evenly within the pores of the support to help inhibit aggregation of the zirconium dioxide particles.

This improves the exhaust gas purification performance of the exhaust gas purification catalyst of the disclosure.

### Porous Support

The porous support of the exhaust gas purification catalyst of the disclosure is not particularly restricted so long as it is a porous support that can be used in an exhaust gas purification catalyst, and it may be a metal oxide, for example, and more specifically an Al-containing metal oxide, even more specifically Al₂O₃ or a complex oxide comprising Al and Zr, and yet more specifically an Al₂O₃—ZrO₂ complex oxide.

The porous support may be particulate, for example. When the porous support is particulate, the mean primary particle size (D50) may be 1 to 1000 μm, for example.

The mean primary particle size (D50) of the porous support may be 1 μm or greater, 10 μm or greater, 50 μm or greater or 100 μm or greater, and 1000 μm or smaller, 500 μm or smaller, 200 μm or smaller or 100 μm or smaller.

The mean primary particle size is the number-average value calculated by observing at least 200 primary particles of the porous support using a scanning electron microscope (SEM) and determining the circle equivalent diameter, using a true circle of equal area for each, and calculating from the circle equivalent diameter.

The initial area-to-weight ratio of the porous support is preferably 45 to 115 m²/g. The initial area-to-weight ratio of the porous support may be 45 m²/g or greater, 50 m²/g or greater, 60 m²/g or greater or 70 m²/g or greater, and 115 m²/g or lower, 110 m²/g or lower, 100 m²/g or lower or 90 m²/g or lower.

The initial area-to-weight ratio of the porous support is the area-to-weight ratio of the porous support comprising the exhaust gas purification catalyst of the disclosure before it is used as a product. The area-to-weight ratio can be calculated by the gas adsorption method, for example.

The pore sizes of the pores of the porous support are not particularly restricted so long as they allow the catalyst metal particles and zirconium dioxide particles to be supported in the pores. The pore sizes may be 10 nm or larger, 50 nm or larger or 100 nm or larger, and 1000 nm or smaller, 500 nm or smaller or 200 nm or smaller, for example.

### Catalyst Metal Particles

The catalyst metal particles are metallic particles with catalytic activity capable of purifying exhaust gases such as CO, HC and NOx. Such metallic particles include precious metals, and more specifically Rh, Pt and Pd. The catalyst metal particles are most preferably Rh.

The ratio of the mass of the catalyst metal particles with respect to the mass of the porous support may be 0.5 to 2.0 mass %. The ratio may be 0.5 mass % or greater, 0.6 mass % or greater, 0.7 mass % or greater or 0.8 mass % or greater, and 2.0 mass % or lower, 1.5 mass % or lower, 1.3 mass % or lower or 1.0 mass % or lower.

The primary particle size (D50) of the catalyst metal particles may be 1.0 to 9.0 nm. The primary particle size (D50) may be 1.0 nm or larger, 2.0 nm or larger, 3.0 nm or larger or 4.0 nm or larger, and 9.0 nm or smaller, 8.0 nm or smaller, 7.0 nm or smaller or 6.0 nm or smaller.

The catalyst metal particles may contact with the zirconium dioxide particles in the pores of the porous support.

### Zirconium Dioxide Particles

The zirconium dioxide particles in the exhaust gas purification catalyst of the disclosure are monoclinic crystals or a mixture of monoclinic crystals and tetragonal crystals, and most preferably they are monoclinic crystals.

The mass ratio of the zirconium dioxide particles with respect to the mass of the porous support is preferably 0.1 to 5.0 mass %. If the mass ratio of the zirconium dioxide particles with respect to the mass of the porous support is 0.1 mass % or greater it will be possible to significantly increase the number of zirconium dioxide particles able to act on the catalyst metal particles. If the mass ratio of the zirconium dioxide particles with respect to the mass of the porous support is 5.0 mass % or lower, on the other hand, the dispersibility of the zirconium dioxide particles in the pores of the porous support will be particularly satisfactory.

The mass ratio of the zirconium dioxide particles with respect to the mass of the porous support may be 0.1 mass % or greater, 0.5 mass % or greater, 1.0 mass % or greater or 1.5 mass % or greater, and 5.0 mass % or lower, 4.0 mass % or lower, 3.0 mass % or lower or 2.0 mass % or lower.

The crystallite diameters of the zirconium dioxide particles are preferably 6.0 to 8.0 nm.

If the crystallite diameters of the zirconium dioxide particles are 6.0 nm or larger, the effect of inhibiting sintering of the catalyst metal particles will be particularly satisfactory. If the crystallite diameters of the zirconium dioxide particles are 8.0 nm or smaller, on the other hand, the heat resistance of the zirconium dioxide particles will be particularly satisfactory, and aggregation of the zirconium dioxide particles by heat can be notably inhibited.

The crystallite diameters of the zirconium dioxide particles may be 6.0 nm or larger, 6.2 nm or larger, 6.4 nm or larger or 6.8 nm or larger, and 8.0 nm or smaller, 7.8 nm or smaller, 7.6 nm or smaller or 7.4 nm or smaller.

The secondary particle size (D50) of the zirconium dioxide particles is preferably 40 nm or smaller. A secondary particle size (D50) for the zirconium dioxide particles in this range can further increase dispersibility of the zirconium dioxide particles in the pores of the porous support.

The secondary particle size (D50) of the zirconium dioxide particles may be 40 nm or smaller, 35 nm or smaller, 30 nm or smaller or 25 nm or smaller, and larger than 0 nm, 5 nm or larger, 10 nm or larger or 15 nm or larger.

### Method for Producing Exhaust Gas Purification Catalyst

The production method of the disclosure is a method for producing the exhaust gas purification catalyst of the disclosure.

The production method of the disclosure comprises the following steps in order: dispersing a porous support and zirconium dioxide particles in an acidic dispersing medium, subsequently drying and firing to load the zirconium dioxide particles inside the pores of the porous support, and loading catalyst metal particles onto the porous support. The zirconium dioxide particles are monoclinic crystals or a mixture of monoclinic crystals and tetragonal crystals.

In the production method of the disclosure, the dispersing medium may be used under acidic conditions to inhibit aggregation of the zirconium dioxide particles in the dispersion, thereby preventing the secondary particle sizes from becoming too large, while also allowing the zirconium dioxide particles to be supported inside the pores of the porous support. This can increase the dispersibility of the zirconium dioxide particles in the pores of the porous support.

The pH of the dispersing medium may be 1.0 or higher, 1.5 or higher or 2.0 or higher, and or lower, 4.5 or lower or 4.0 or lower, for example. The most preferred pH range is 2.5 to 3.5.

The method of loading the catalyst metal particles into the pores of the porous support is not particularly restricted, and for example, a catalyst metal may be added to and stirred in a dispersing medium in which the porous support with zirconium dioxide supported in the pores is dispersed, and then dried and fired to load the catalyst metal into the pores of the porous support.

The porous support, the catalyst metal particles and the zirconium dioxide particles are as described above under “<Exhaust gas purification catalyst>”.

### EXAMPLES

### Examples 1 to 6 and Comparative Examples 1 to 6

### Preparation of Exhaust Gas Purification Catalyst

### Comparative Example 1

A dispersion of Al₂O₃—ZrO₂ powder as a porous support in water and a dispersion of Rh particles (mean primary particle size (D59)=2 nm) were mixed and the mixture was stirred for 1 hour.

The mixture was then heated on a hot stirrer to evaporate off the water and obtain a precipitate. The precipitate was dried for a day and a night at 120° C., and then fired in air at 500° C. to obtain an exhaust gas purification catalyst for Comparative Example 1.

### Example 1

To a dispersion of Al₂O₃—ZrO₂ powder as a porous support in water there was added nitric acid to adjust the pH to 3. The dispersion was mixed with a ZrO₂ particle dispersion at pH 3 (mixture of monoclinic crystals and tetragonal crystals, secondary particle size (D50) of ZrO₂ particles in solution=15 nm), and the mixture was stirred for 1 hour. The amount of ZrO₂ particles in the mixture was 4.0 mass % with respect to the Al₂O₃—ZrO₂ powder.

The mixture was then heated on a hot stirrer to evaporate off the water and obtain a precipitate. The precipitate was subsequent dried for a day and a night at 120° C. and additionally fired in air at 500° C. to obtain Al₂O₃—ZrO₂ powder supporting ZrO₂ particles in the pores.

The Al₂O₃—ZrO₂ powder with ZrO₂ particles supported in the pores was then used for loading of Rh particles into the pores of the Al₂O₃—ZrO₂ powder in the same manner as Comparative Example 1, to obtain an exhaust gas purification catalyst for Example 1.

### Examples 2 to 4

Exhaust gas purification catalysts for Examples 2 to 4 were obtained in the same manner as Example 1, except that for the step of obtaining the Al₂O₃—ZrO₂ powder with ZrO₂ particles supported in the pores, the amounts of ZrO₂ particles in the liquid mixture were 0.5 mass %, 1.0 mass % and 2.0 mass %, respectively, with respect to the Al₂O₃—ZrO₂ powder.

### Example 5

An exhaust gas purification catalyst for Example 5 was obtained in the same manner as Example 1, except for using monoclinic ZrO₂ particle crystals (secondary particle size (D50) of ZrO₂ particles in solution=38 nm).

### Example 6

An exhaust gas purification catalyst for Example 6 was obtained in the same manner as Example 5, except for using Al₂O₃ powder as the porous support.

### Comparative Example 2

An exhaust gas purification catalyst for Comparative Example 2 was obtained in the same manner as Example 1, except that for the step of obtaining Al₂O₃—ZrO₂ powder with ZrO₂ particles supported in the pores, ammonia was added to both the ZrO₂ particle dispersion and the dispersion of Al₂O₃—ZrO₂ powder in water to adjust the pH of both to 7, and then the mixture was stirred for 1 hour. Adjusting the pH of the ZrO₂ particle dispersion to 7 produced aggregation of the ZrO₂ particles in the dispersion to result in a secondary particle size (D50) of nm.

### Comparative Example 3

To a dispersion of zirconium in water there was added citric acid in an equimolar amount with zirconium, and the mixture was stirred to dissolve the zirconium. Zirconium oxynitrate dihydrate was then added to obtain an aqueous zirconium nitrate solution. The prepared aqueous zirconium nitrate solution was then added dropwise to tetraethylammonium hydroxide (10% aqueous solution) to obtain a solution of zirconium hydroxide (ZrO₂ secondary particle size (D50)=10 nm).

An exhaust gas purification catalyst for Comparative Example 3 was obtained in the same manner as Example 1, except that this zirconium hydroxide solution was used instead of the ZrO₂ particle dispersion. In the exhaust gas purification catalyst of Comparative Example 3, the zirconium dioxide supported in the pores of the porous support was amorphous.

### Comparative Example 4

An exhaust gas purification catalyst for Comparative Example 4 was obtained in the same manner as Example 1, except that a ZrO₂ dispersion of tetragonal ZrO₂ particles (secondary particle size (D50) of ZrO₂ particles in solution=6 nm) was used in the step of obtaining Al₂O₃—ZrO₂ powder with ZrO₂ particles supported in the pores.

### Comparative Example 5

An exhaust gas purification catalyst for Comparative Example 5 was obtained in the same manner as Example 1, except that for the step of obtaining the Al₂O₃—ZrO₂ powder with ZrO₂ particles supported in the pores, the amount of ZrO₂ particles in the liquid mixture was 8.0 mass % with respect to the Al₂O₃—ZrO₂ powder.

### Comparative Example 6

An exhaust gas purification catalyst for Comparative Example 6 was obtained in the same manner as Comparative Example 1, except for using AlO₃ as the porous support.

### Electron Beam Microanalyzer Analysis

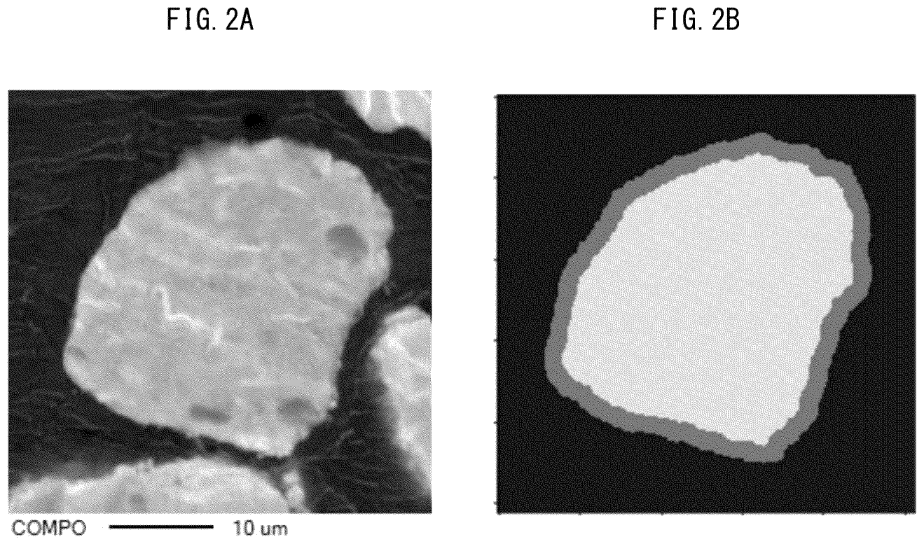

For the exhaust gas purification catalysts of Comparative Examples 2 to 5 and Examples 1 to 6, the distribution of the zirconium dioxide particles in the pores of the porous support was measured using an electron probe microanalyzer (EPMA) (EPMA-8050G by Shimadzu, beam current: 15 kV, 50 nA). For measurement, a surface region of the porous support up to 1.5 μm from the surface, and the region inward from the surface region, were first cut out from the obtained image as shown in FIG. 2A and 2B. The amount of Zr and the amount (count) of Al detected by EPMA per unit area in the porous support in each region were estimated to calculate the Zr/Al ratio. Specifically, calculation was carried out using the following formula.

Homogeneity (%)=(Zr/Al ratio in surface region/Zr/Al ratio in region inward from surface region)×100

A unity (%) of 95 to 105 mol % was considered homogeneous, and other values were considered non-homogeneous.

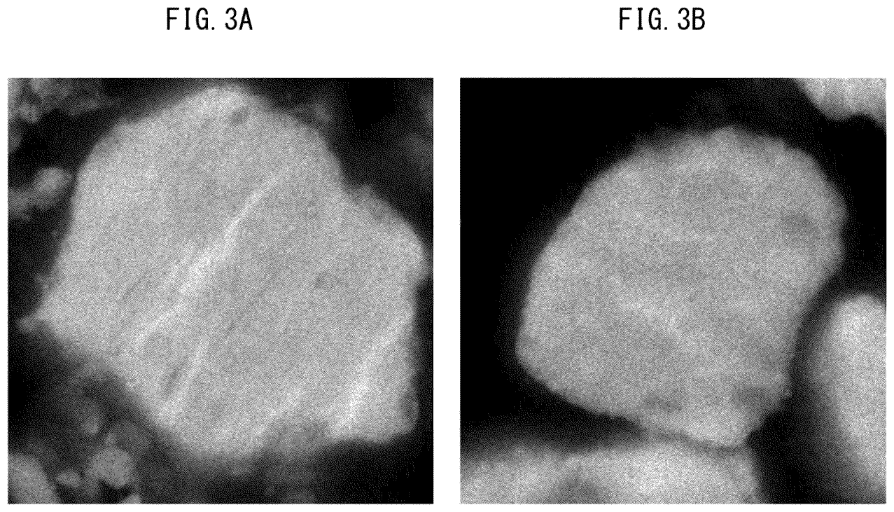

FIG. 3A and 3B respectively show the results of Zr mapping for Example 1 (FIG. 3A) and Comparative Example 2 (FIG. 3B).

The exhaust gas purification catalyst of Example 1 had a homogeneity of 97 mol %, and the zirconium dioxide particles in the region inward from the surface region were uniformly supported in essentially a consistent amount. The zirconium dioxide particles of Comparative Examples 3 and 4 and Examples 2 to 6 were likewise uniformly supported in the pores of the porous support.

In contrast, the exhaust gas purification catalyst of Comparative Example 2 had a homogeneity of 108 mol %, confirming that the zirconium dioxide particles were abundantly supported, i.e. unevenly supported, in the surface region. The zirconium dioxide particles of Comparative Example 5 were also unevenly supported in the pores of the porous support.

Since the zirconium dioxide particles in Comparative Example 2 were supported on the porous support while aggregated in solution, it is possible that the zirconium dioxide particles did not penetrate deeply into the pores of the porous support, and that this resulted in a large loading mass in the surface region compared to the inward region.

In Comparative Example 5, the amount of zirconium dioxide particles in the mixture was an excess amount of 8 mass % in the step of obtaining Al₂O₃—ZrO₂ powder with ZrO₂ particles supported in the pores, presumably resulting in an excess amount of zirconium dioxide particles filling the pores of the porous support, and producing a larger loading mass in the surface region compared to the inward region.

### Evaluation of Exhaust Gas Purification Performance

The catalysts of the Examples and Comparative Examples were evaluated for exhaust gas purification performance (three-way purification catalyst performance).

In order to simulate an actual coated layer catalyst, the powders of each of the Examples and Comparative Examples were mixed with Al₂O₃, Al₂O₃—CeO₂—ZrO₂ and CeO₂—ZrO₂ powders, and the mixture was press molded by cold isostatic pressing (CIP) under 1 ton of pressure, and then sifted while pulverizing to obtain catalyst pellets.

A 2 g portion of the catalyst pellets was then placed in a circulating reactor and heated to 500° C. in model gas for evaluation, at a temperature-elevating rate of 50° C./min, after which it was held for 10 minutes at that temperature and then allowed to cool to 100° C. While subsequently heating at a temperature-elevating rate of 20° C./min, the three-way purification catalyst performance during temperature increase was measured and the temperature for achieving 50% purification of NOx was calculated.

The composition of the model gas for evaluation was 1600 ppm NO, 6100 ppm 02, 10,000 ppm CO₂, 5000 ppm CO, 30,000 H₂O, and the remainder N₂. The gas flow rate was 20 L/min.

### Results

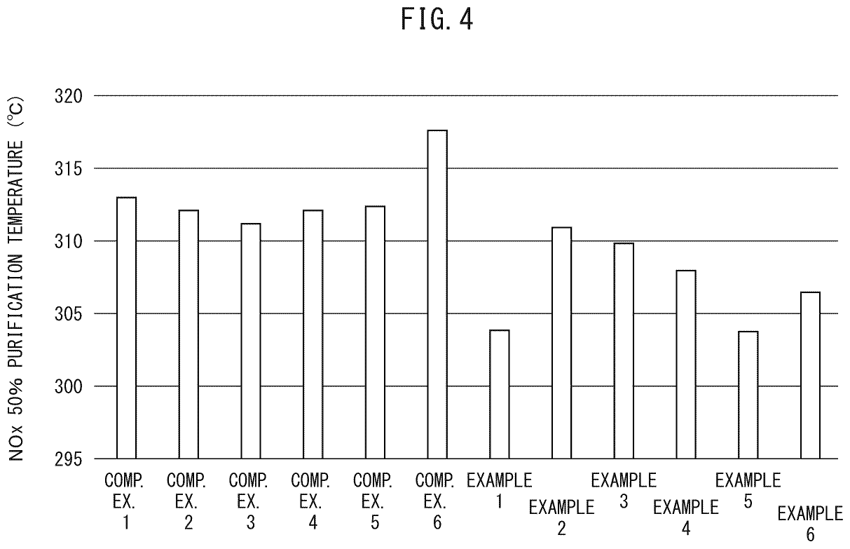

The production conditions and exhaust gas purification performance evaluation results for each exhaust gas purification catalyst are shown in FIG. 4 and Table 1.

TABLE 1

| | Conditions | | | | | | | | |
|---|---|---|---|---|---|---|---|---|---|
| | | Catalyst metal | | ZrO₂ | | | | | |
| | | | Mean | | | ZrO₂ | | | |
| | | | primary | | | secondary | | | Results |
| | | | particle | | | particle | | | NO× 50% |
| | | | size | | Crystallite | size in | Loading | | purification |
| | | | (D50) | Crystalline | diameter | solution | mass | | temperature |
| Example | Support | Type | (nm) | structure | (nm) | (nm) | (mass %) | Homogeneity | (° C.) |
| Comp. | Al₂O₃—ZrO₂ | Rh | 2 | — | — | — | — | — | 313.0 |
| Example 1 | | | | | | | | | |
| Comp. | Al₂O₃—ZrO₂ | Rh | 2 | Mixed crystals | 6~8 | 60 | 4.0 | Non-homogeneous | 312.1 |
| Example 2 | | | | (monoclinic/tetragonal) | | | | | |
| Comp. | Al₂O₃—ZrO₂ | Rh | 2 | Amorphous | 6~8 | 10 | 4.0 | Homogeneous | 311.2 |
| Example 3 | | | | | | | | | |
| Comp. | Al₂O₃—ZrO₂ | Rh | 2 | Tetragonal | 6~8 | 6 | 4.0 | Homogeneous | 312.2 |
| Example 4 | | | | | | | | | |
| Comp. | Al₂O₃—ZrO₂ | Rh | 2 | Mixed crystals | 6~8 | 15 | 8.0 | Non-homogeneous | 312.4 |
| Example 5 | | | | (monoclinic/tetragonal) | | | | | |
| Comp. | Al₂O₃ | Rh | 2 | — | — | — | — | — | 317.7 |
| Example 6 | | | | | | | | | |
| Example 1 | Al₂O₃—ZrO₂ | Rh | 2 | Mixed crystals | 6~8 | 15 | 4.0 | Homogeneous | 303.9 |
| | | | | (monoclinic/tetragonal) | | | | | |
| Example 2 | Al₂O₃—ZrO₂ | Rh | 2 | Mixed crystals | 6~8 | 15 | 0.5 | Homogeneous | 311.0 |
| | | | | (monoclinic/tetragonal) | | | | | |
| Example 3 | A1₂O₃—ZrO₂ | Rh | 2 | Mixed crystals | 6~8 | 15 | 1.0 | Homogeneous | 309.9 |
| | | | | (monoclinic/tetragonal) | | | | | |
| Example 4 | Al₂O₃—ZrO₂ | Rh | 2 | Mixed crystals | 6~8 | 15 | 2.0 | Homogeneous | 308.0 |
| | | | | (monoclinic/tetragonal) | | | | | |
| Example 5 | Al₂O₃—ZrO₂ | Rh | 2 | Monoclinic | 6~8 | 38 | 4.0 | Homogeneous | 303.8 |
| Example 6 | Al₂O₃ | Rh | 2 | Monoclinic | 6~8 | 38 | 4.0 | Homogeneous | 306.5 |

As shown in FIG. 4 and Table 1, increasing the zirconium dioxide content from 0.5 mass % to 8 mass % (Examples 1 to 4 and Comparative Example 5) resulted in higher proximity between the Rh and zirconium dioxide particles, which was thought to inhibit sintering of the Rh and to lead to a lower temperature for achieving 50% purification of NOx (° C.). With a zirconium dioxide content of 8.0 mass % as in Comparative Example 5, however, homogeneity of the zirconium dioxide particles in the pores of the porous support was poor, which was thought to result in lower heat resistance of the zirconium dioxide particles and an insufficient effect of inhibiting Rh degradation.

When the crystal structure of the zirconium dioxide particles was monoclinic as in Example it was possible to further lower the temperature for achieving 50% purification of NOx (° C.) compared to mixed crystals.

As demonstrated by Examples 5 and 6, using Al₂O₃—ZrO₂ complex oxide for the porous support made it possible to further lower the temperature for achieving 50% purification of NOx (° C.) compared to Al₂O₃ (Example 6).

### REFERENCE SIGNS LIST

1 Exhaust gas purification catalyst
11 Surface region
12 Region inward from surface region

1. An exhaust gas purification catalyst having a porous support, catalyst metal particles supported in the pores of the porous support, and zirconium dioxide particles supported in the pores of the porous support,
wherein the zirconium dioxide particles are supported in a uniformly dispersed manner in the pores of the porous support, as monoclinic crystals or a mixture of monoclinic crystals and tetragonal crystals,
where “supported in a uniformly dispersed manner” means that when the exhaust gas purification catalyst is measured with an electron beam microanalyzer, the proportion of the abundance ratio of zirconium in a surface region up to a depth of 1.5 μm from the exhaust gas purification catalyst surface with respect to the abundance ratio of zirconium in the region inward from that surface region of the exhaust gas purification catalyst, is 95 to 105 mol %.

2. The exhaust gas purification catalyst according to claim 1, wherein the zirconium dioxide particles are monoclinic crystals.

3. The exhaust gas purification catalyst according to claim 1, wherein the ratio of the mass of the zirconium dioxide particles with respect to the mass of the porous support is 0.1 to 5.0 mass %.

4. The exhaust gas purification catalyst according to claim 1, wherein the crystallite diameters of the zirconium dioxide particles are 6.0 to 8.0 nm.

5. The exhaust gas purification catalyst according to claim 1, wherein the secondary particle size (D50) of the zirconium dioxide particles is 40 nm or smaller.

6. The exhaust gas purification catalyst according to claim 1, wherein the catalyst metal particles are Rh particles.

7. The exhaust gas purification catalyst according to claim 1, wherein the ratio of the mass of the catalyst metal particles with respect to the mass of the porous support is 0.5 to 2.0 mass %.

8. The exhaust gas purification catalyst according to claim 1, wherein the primary particle size (D50) of the catalyst metal particles is 1.0 to 9.0 nm.

9. The exhaust gas purification catalyst according to claim 1, wherein the porous support is a complex oxide of Al and Zr.

10. The exhaust gas purification catalyst according to claim 1, wherein the initial area-to-weight ratio of the porous support is 45 to 115 m²/g.
